(19) United States
(12) Patent Application Publication
(10) Pub. No.: US 2011/0101743 A1
(43) Pub. Date: May 5, 2011

(54) STRADDLE-TYPE SEAT FOR A VEHICLE

(75) Inventor: Nicolas Deluy, Sherbrooke (CA)

(73) Assignee: BOMBARDIER RECREATIONAL PRODUCTS INC., Valcourt, QC (CA)

(21) Appl. No.: 12/999,099

(22) PCT Filed: Jun. 30, 2008
(86) PCT No.: PCT/US08/68792

§ 371 Date: Dec. 15, 2010

(51) Int. Cl. B60N 2/44; B62J 1/00

(52) U.S. Cl. 297/215.1

(57) ABSTRACT

A straddle-type seat has an elongated seat portion and a backrest connected to the elongated seat portion. The backrest has an inner side and an outer side opposite the inner side. The inner side is configured to provide support to at least the pelvic region of a user. The backrest contacts the surface of the elongated seat portion. At least one passage is located near a junction of the backrest and the elongated seat portion. The passage extends from at least the inner side to the outer side of the backrest. A vehicle having the straddle-type seat is also disclosed.

### FIELD OF THE INVENTION

The present invention relates to a straddle-type seat for a vehicle.

### BACKGROUND OF THE INVENTION

Seat designs vary from one type of vehicle to another. When a straddle-type vehicle is principally used for touring purposes the seating surface is slight inclined to the rear and contoured by a back rest projecting upward from the surface to provide a pelvic or a lower back support for the user. This backrest along with the seating surface creates an area where rain water can accumulate. This causes an inconvenience to the user and also allows the water more time to penetrate the covering material and/or stitching of the seat and to soak into the foam in the seat.

Therefore, there is a need for a straddle-type seat which will reduces accumulation of rain water along the seating surface and the back rest.

### SUMMARY OF THE INVENTION

It is an object of the present invention to ameliorate at least some of the inconveniences present in the prior art.

It is also an object of the present invention to provide an elongate straddle-type seat with a back rest that has a passage for draining rainwater that would otherwise accumulate in the seating area adjacent the backrest.

In one aspect, the invention provides a straddle-type seat having an elongated seat portion, and a backrest connected to the elongated seat portion. The backrest has an inner side and an outer side opposite the inner side. The inner side is configured to provide support to at least the pelvic region of a user. The backrest contacts the surface of the elongate seat portion. At least one passage is located near the junction of the backrest and the elongated seat portion. The at least one passage extends from the inner side to the outer side of the backrest.

In another aspect, the at least one passage is located at the junction of the backrest and the elongated seat portion.

In a further aspect, the at least one passage comprises a plurality of passages.

In an additional aspect, the at least one passage extends at least through the backrest.

In yet another aspect, the at least one passage extends through at least the seat portion

In another aspect, a shape of a cross-section of the at least one passage is one of a V-shape, a U-shape, and a T-shape.

In an additional aspect, the at least one passage is an aperture extending through at least the backrest.

In a further aspect, the at least one passage is an aperture extending through at least the seat portion.

In another aspect, the elongated seat portion has a front seat portion and a back seat portion. The front seat portion is offset from the back seat portion. The backrest is a first backrest being configured to provide support to at least a pelvic region of a user of the back seat portion. The seat also has a second backrest extending from the front seat portion to the back seat portion. The second backrest is configured to provide support to at least a pelvic region of a user of the front seat portion.

In an further aspect, an aperture extends through the front seat portion.

In an additional aspect, the backrest has an upper point. The upper point is a point on the backrest which is located furthest from the junction. The elongated seat portion has a seating surface disposed adjacent to the backrest. The at least one passage has a negative slope that extends in a direction away from the upper point as it extends from the inner side to the outer side of the backrest. The seating surface has a negative slope.

In a another aspect, the invention provides a straddle-type vehicle having a vehicle body, an engine connected to the vehicle body, a handlebar operatively connected to the vehicle body, and an elongated seat portion disposed on the vehicle body rearwardly of the handlebar. A backrest is connected to the elongated seat portion. The backrest has an inner side and an outer side opposite the inner side. The inner side is configured to provide support to at least a pelvic region of a user. The backrest contacts a surface of the elongated seat portion. At least one passage is located near a junction of the backrest and the elongated seat portion. The passage extends from at least the inner side to the outer side of the backrest.

In another aspect, the at least one passage is located at the junction of the backrest and the elongated seat portion.

In a further aspect, the at least one passage comprises a plurality of passages.

In an additional aspect, the at least one passage extends at least through the backrest.

In yet another aspect, the at least one passage extends through at least the seat portion.

In another aspect, a shape of a cross-section of the at least one passage is one of a V-shape, a U-shape, and a T-shape.

In an additional aspect, the at least one passage is an aperture extending through at least the backrest.

In a further aspect, the at least one passage is an aperture extending through at least the seat portion.

In yet another aspect, the seat portion has a front seat portion and a back seat portion. The front seat portion is disposed vertically lower than the back seat portion.

In a further aspect, an aperture extends through the front seat portion.

In yet a another aspect, the seat portion has a front seat portion and a back seat portion. The back seat portion has a negative slope towards a back of the vehicle. A majority of a lower portion of the at least one passage is disposed vertically lower than the back seat portion. The at least one passage extends downwardly as the at least one passage extends towards a back of the vehicle.

For purposes of this application, terms used to locate elements on the vehicle, such as “front”, “back”, “rear”, “left”, “right”, “up”, “down”, “above”, and “below”, are as they would normally be understood by a rider of the vehicle sitting on the vehicle in a forwardly facing, driving position. The term “longitudinal” means extending from the front to the back. Also, the term “passage” means: “a passage”, “an aperture”, “a hole”, “a channel”, “an opening”, “an orifice”, “a gap”, “a slit”, “a crack”, “a conduit”, “a waterway”, “a path”, “a canal”, or “a puncture”.

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a perspective view, taken from a rear, left side, of a vehicle in accordance with the present invention;

FIG. 2 is a top view of the vehicle of FIG. 1;

FIG. 3 is front view of the vehicle of FIG. 1;

FIG. 4 is a back view of the vehicle of FIG. 1;

FIG. 5 is a left side elevation view of the vehicle of FIG. 1;

FIG. 6 is a perspective view, taken from a front, right side, of a first embodiment of the straddle-type seat of the vehicle of FIG. 1;

FIG. 7 is a top view of the seat of FIG. 6;

FIG. 8 is a left side view of the seat of FIG. 6;

FIG. 9 is a back view of the seat of FIG. 6;

FIG. 10 is a cross-sectional view of the seat of FIG. 6 taken along line A-A in FIG. 7;

FIG. 11 is a cross-sectional view of an alternative embodiment of the straddle-type seat of FIG. 6 taken along a longitudinal centerline thereof;

FIG. 12 is a rear view of the another alternative embodiment of the straddle-type seat of FIG. 6;

FIG. 13 is a rear view of an additional alternative embodiment of the straddle-type seat of FIG. 6;

FIG. 14 is a rear view of yet another alternative embodiment of the straddle-type seat of FIG. 6;

FIG. 15 is a is a rear view of yet another alternative embodiment of the straddle-type seat of FIG. 6;

FIG. 16 is a is a top view of yet one more alternative embodiment of the straddle-type seat of FIG. 6; and

FIG. 17 is a top view of an additional alternative embodiment of the straddle-type seat.

### DETAILED DESCRIPTION OF THE PREFERRED EMBODIMENTS

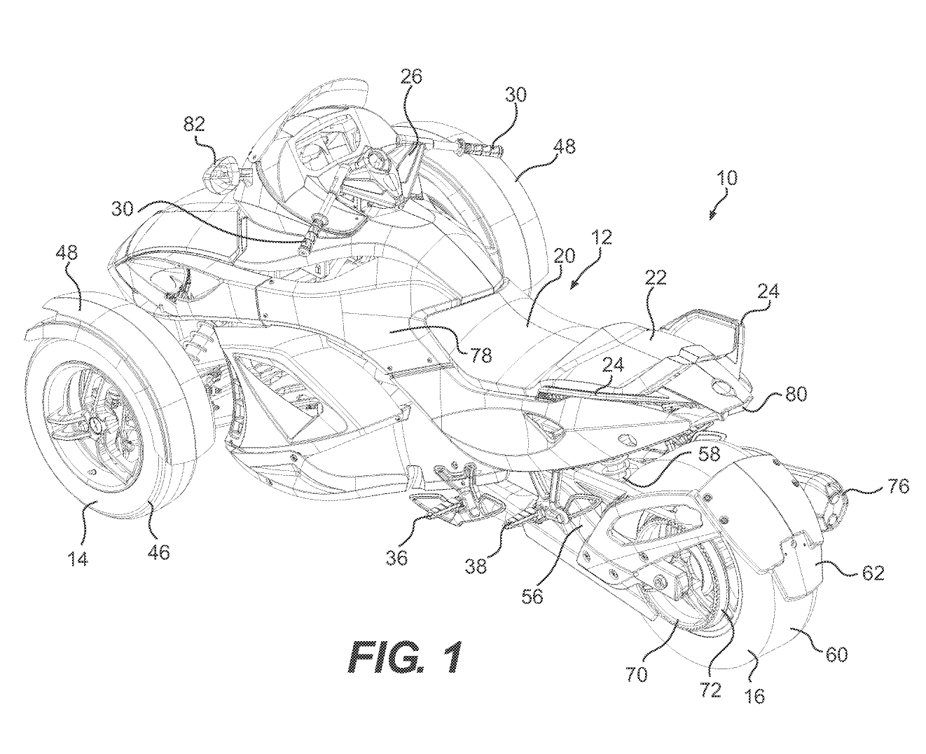

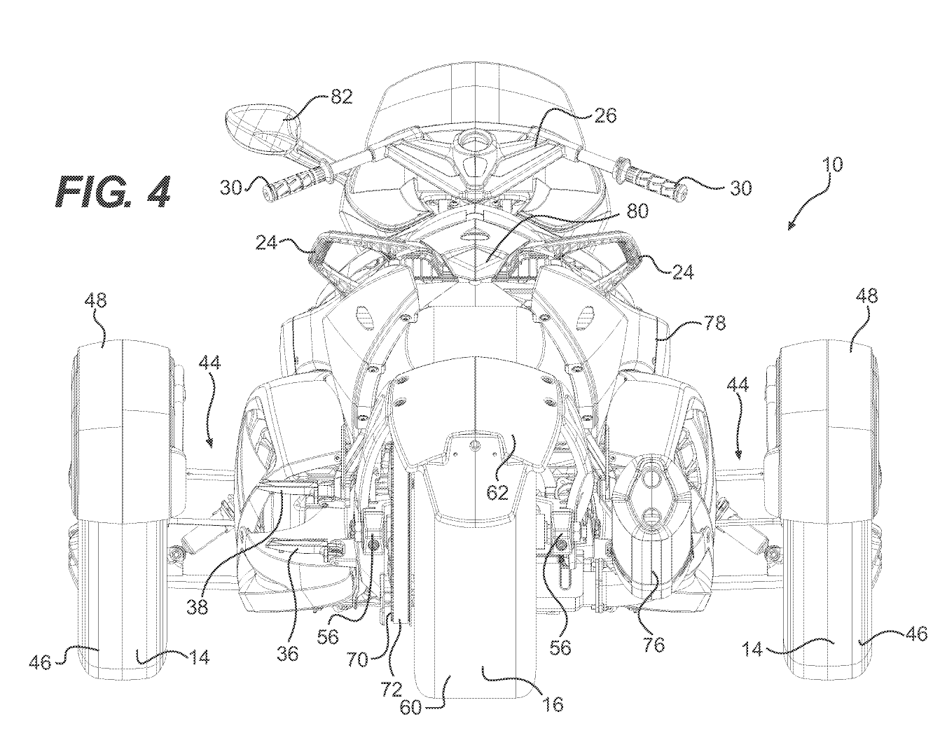

The present invention could be described with respect to a vehicle 10 in having a straddle seat 12, two front wheels 14, and one rear wheel 16, as illustrated in FIGS. 1 to 5. However, it is contemplated that the vehicle 10 could also have one front wheel and two rear wheels. It is also contemplated that some aspects of the present invention could be used in other straddle-type vehicles such as, but not limited to, all-terrain vehicles, motorcycles, and personal watercraft. U.S. Pat. No. 7,315,779, issued Jan. 1, 2008, the entirety of which is incorporated herein by reference, describes some of these other contemplated vehicles.

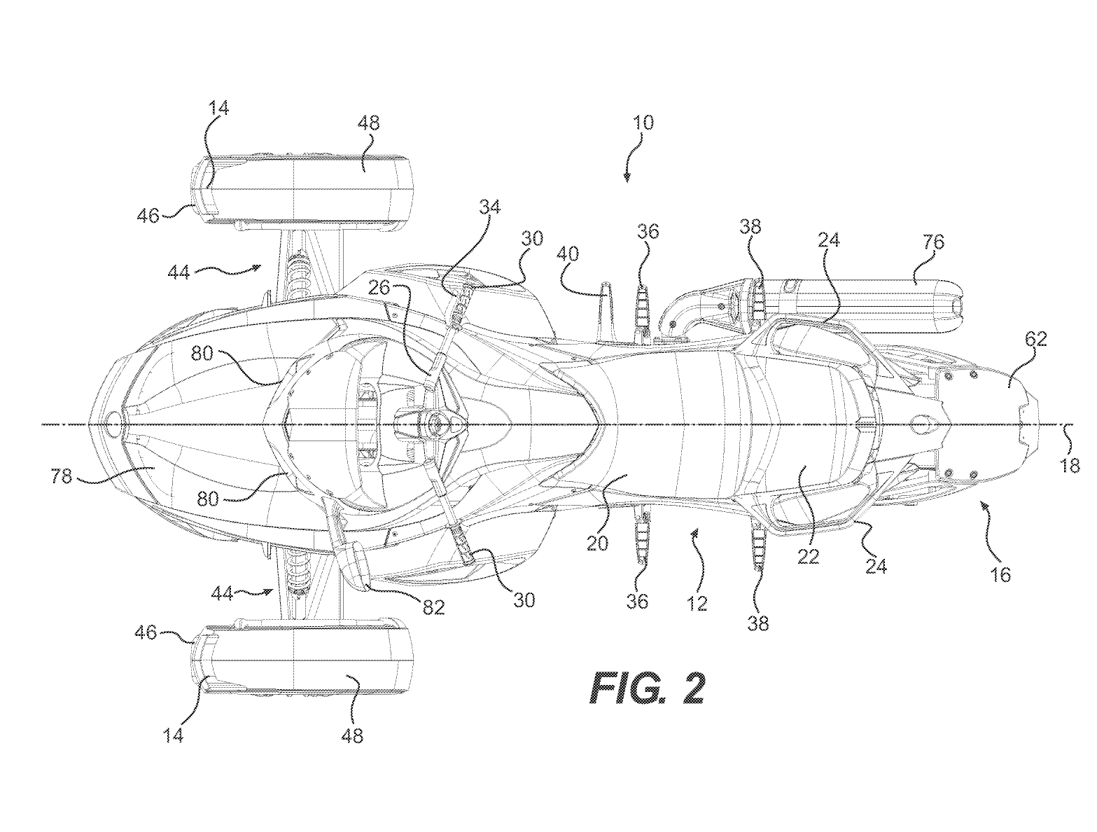

As seen in FIGS. 1 to 5, the vehicle 10 has a straddle-type seat 12 located at least partially rearwardly of a center of the vehicle 10 and disposed along the longitudinal centerline 18 (FIG. 2) thereof. The straddle-type seat 12 has a front seat portion 20 for accommodating a driver, and a back seat portion 22 for accommodating a passenger behind the driver. The back seat portion 22 is higher than the front seat portion 20 to permit the passenger to see in front of the vehicle 10 over the driver. A pair of handles 24 are provided on either sides of the back seat portion 22 for the passenger to hold onto. It is contemplated that the straddle-type seat 12 could be disposed at a different longitudinal location depending on the particular ergonomics of the vehicle 10. It is also contemplated that the straddle-type seat 12 could have only the first portion 20.

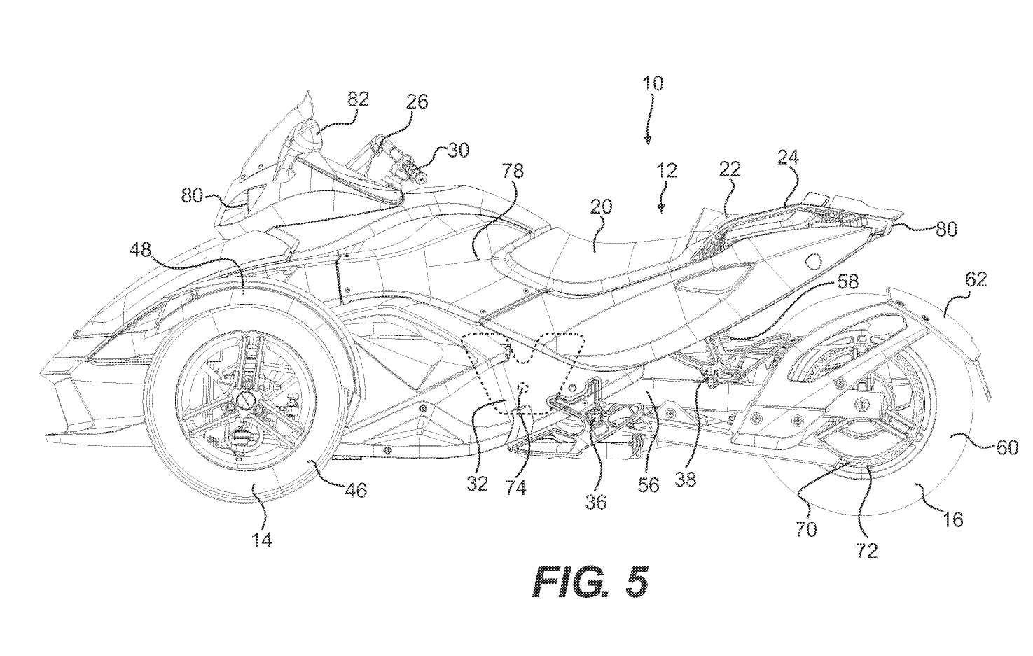

A steering assembly is disposed forwardly of the straddle-type seat 12 to allow a driver to steer the two front wheels 14. The steering assembly has handlebars 26 connected to a steering column (not shown). The steering column is connected to the two front wheels 14 via a steering linkage (not shown), such that turning the handlebars 26 turns the steering column which, through the steering linkage, turns the wheels 14. The handlebars 26 are provided with handles 30 for the driver to hold. The right handle 30 can twist and acts as the throttle controller for the engine 32 (shown schematically and in phantom in FIG. 5). It is contemplated, that the throttle could also be controlled by a separate lever disposed near one of the handles 30. A brake lever, in the form of a hand brake lever 34, is provided near the right handle 30 for braking the vehicle 10, as will be explained in greater details below. As seen in the figures, the hand brake lever 34 is provided generally forwardly of the right handle 30 so as to be actuated by multiple fingers of a user, however, it is contemplated that the hand brake lever 34 could be provided generally forwardly of the left handle 30. Other types of brake levers commonly known to those skilled in the art are also contemplated.

A pair of driver foot pegs 36 are provided on either sides of the vehicle 10 below the first portion 20 of the straddle-type seat 12 for a driver to rest his feet thereon. Similarly a pair of passenger foot pegs 38 are provided on either sides of the vehicle 10 below the back seat portion 22 of the straddle-type seat 12 for a passenger to rest his feet thereon. Another brake lever, in the form of a foot brake lever 40, is provided on a right side of the vehicle 10 below the front seat portion 20 of the straddle-type seat 12 for braking the vehicle 10. As best seen in FIG. 2, the foot brake lever 40 is preferably provided near the right driver foot peg 36 such that the driver can actuate the foot brake lever 40 while a portion of his foot remains on the right driver foot peg 36. The foot brake lever 40 also preferably pivots about an axis which is coaxial with the right driver foot peg 36 in order to facilitate actuation of the foot brake lever 40 by the driver.

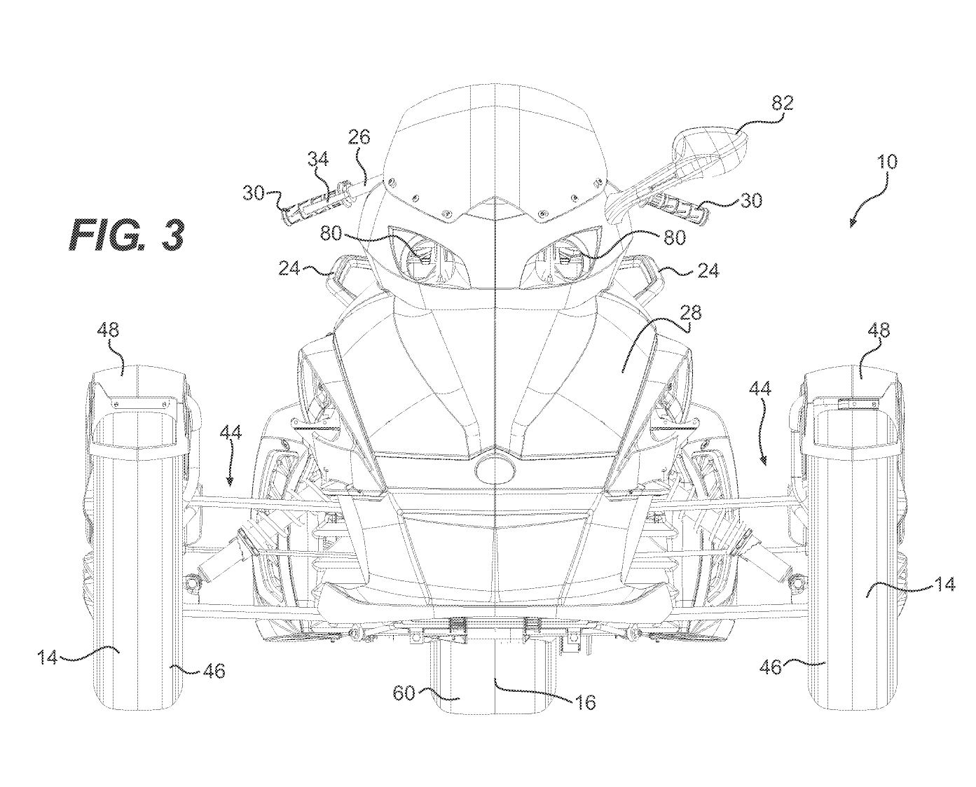

Each of the two front wheels 14 is mounted to the frame (not shown) of the vehicle 10 via a suspension assembly 44. The suspension assembly 44 is preferably a double A-arm suspension, as best shown in FIGS. 2 and 3, but it is contemplated that other types of suspensions could be used, such as a McPherson suspension. As previously mentioned, the front wheels 14 are steered via a steering assembly. Each of the two front wheels 14 has a tire 46 thereon which is suitable for road use. The tires 46 are preferably inflated to a pressure between 138 kPa and 345 kPa. A fairing 48 is disposed over each tire 46 to protect the driver from dirt and water which can be lifted by the tire 46 while it is rolling. Each of the two front wheels 14 is also provided with a brake (not shown). The brake is preferably a disc brake mounted onto a wheel hub of each wheel 14, however other types of brakes are contemplated.

The rear wheel 16 is mounted to the frame (not shown) via a swing arm 56. The swing arm 56 preferably has two arms pivotally mounted at a front thereof to the frame (not shown) and between which the rear wheel 16 is rotatably mounted at the rear of the two arms. A shock absorber 58 is disposed between the swing arm 56 and the frame (now shown). The rear wheel 16 has a tire 60 thereon which is suitable for road use. Preferably, the tire 60 is wider than the tires 46. It is contemplated that the tire 60 could have a smaller width or the same width as the tires 46. It is also contemplated that the rear wheel 16 could have two or more tires disposed next to each other thereon. The tire 60 is preferably inflated to a pressure between 138 kPa and 345 kPa. A fairing 62 is disposed over the tire 60 to protect the driver from dirt and water which can be lifted by the tire 60 while it is rolling. The rear wheel 16 is provided with a brake (not shown).

A wheel sprocket 70 is mounted to a left side of the rear wheel 16. A belt 72 is disposed about the wheel sprocket 70 and an engine sprocket (not shown) to transmit power from the engine 32 to the rear wheel 16. The engine sprocket is disposed about the output shaft 74 (shown schematically in FIG. 5) of the engine 32. The output shaft 74 extends horizontally and perpendicularly to the longitudinal centerline 18 of the vehicle 10. It is contemplated that a continuously variable transmission (CVT) could be provided between the output shaft 74 and the engine sprocket.

Many other components not specifically described in this application, but well known to people skilled in the art, are mounted to the frame (not shown) to permit proper operation of the vehicle 10. Examples of these components are an air box, radiators, fuel tank, oil tank, and a battery. An exhaust pipe 76 extending on the right side of the vehicle 10 towards the rear thereof is attached to an exhaust port (not shown) of the engine 32 to improve engine performance and to reduce the noise level of the engine 32. A vehicle body 78 is attached to the frame (not shown) in order to protect the components mounted to the frame from the elements and to make the vehicle 10 aesthetically pleasing. Front of the vehicle 28 is shaped to make it more aerodynamic. Components necessary to make vehicle 10 suitable for road use, such as lights 80 and a rear view mirror 82, are mounted to the vehicle body 78.

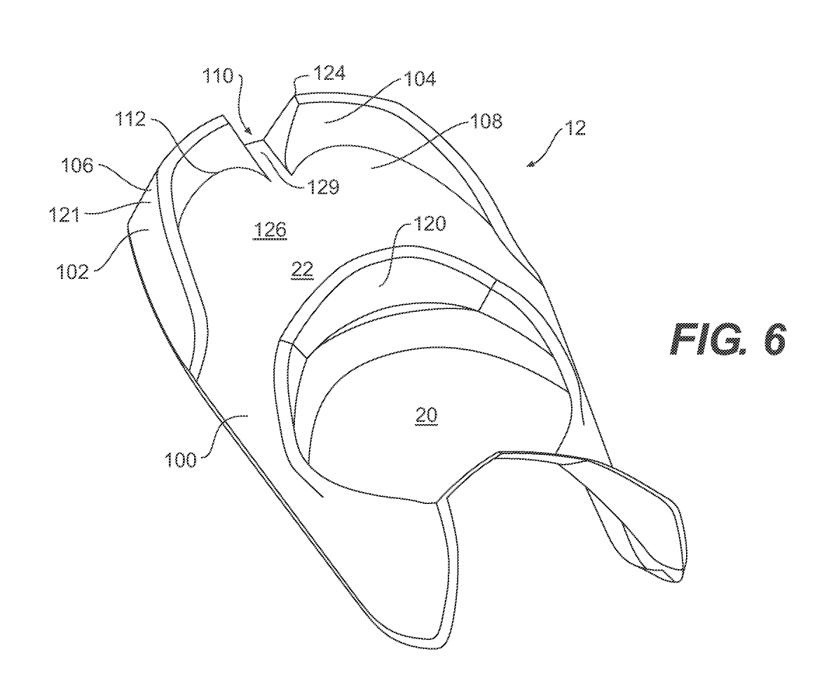

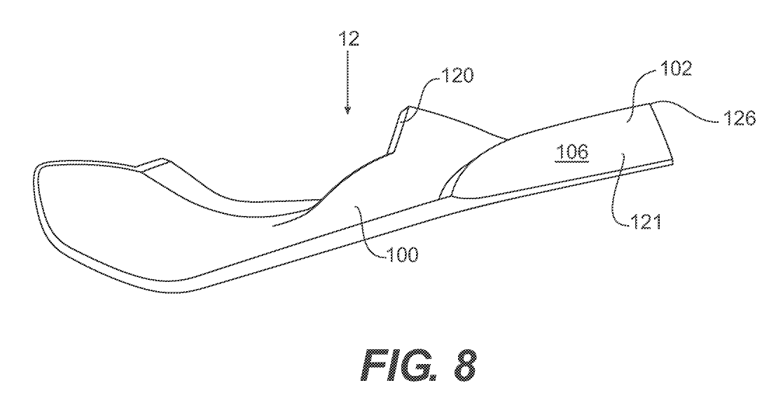

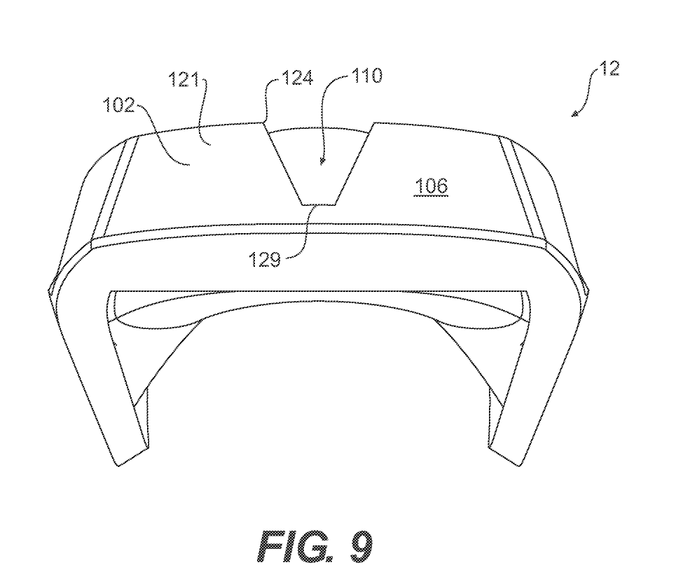

As seen in FIGS. 6 to 10, the straddle-type seat 12 has an elongated seat portion 100, which has a front seat portion 20 for accommodating the driver and a back seat portion 22 for accommodating the passenger behind the driver. A backrest 102 is located adjacent to the back seat portion 22 and is configured to support the pelvic region or the lower back of the user. The backrest 102 has an inner side 104 and an outer side 106 opposite the inner side 104. The backrest 102 is attached along the periphery of the back seat portion 22. The elongated seat portion 20 of the straddle-type seat 12 does not extend beyond the outer side 106 of the back rest 102. However, it is contemplated that the elongated seat portion 22 could extend rearwardly of the outer side 106 of the backrest 102.

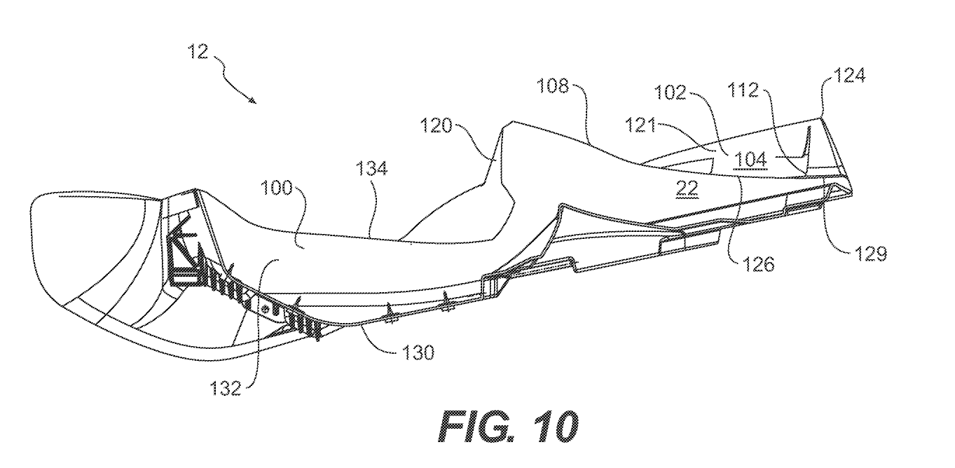

As best seen in FIG. 10, the straddle-type seat 12 has a base 130, preferably made of plastic. A foam 132 having the shape of the elongated seat portion 100 and the backrest 102 is disposed on the base 130. The foam 132 is covered by one or more pieces of material 134, such a vinyl.

The straddle-type seat 12 has a passage 110 located on the junction 112 of the backrest 102 and the elongated seat portion 100. The passage 110 extends along the width of the backrest 102 from the inner side 104 to the outer side 106 of the backrest 102. The passage is configured to drain most of the rain water that would otherwise accumulate in the area of the junction 112.

The backrest 102 has an upper point 124. The upper point 124 is the point of the backrest 102 located furthest from the junction 112. To facilitate the drainage of the rain water, the passage 110 is inclined towards the back of the of the vehicle 10, or in other words, the passage 110 extends away from the upper point 124 as it extends from the inner side 104 to the outer side 106 of the backrest 102. The passage 110 has a negative slope as it extends from its inlet to its outlet. The elongated seat portion 100 has a seating surface 126 disposed adjacent the backrest 102. The seating surface 126 also has a negative slope, or, in other words, the seating surface 126 is inclined towards the back of the vehicle 10.

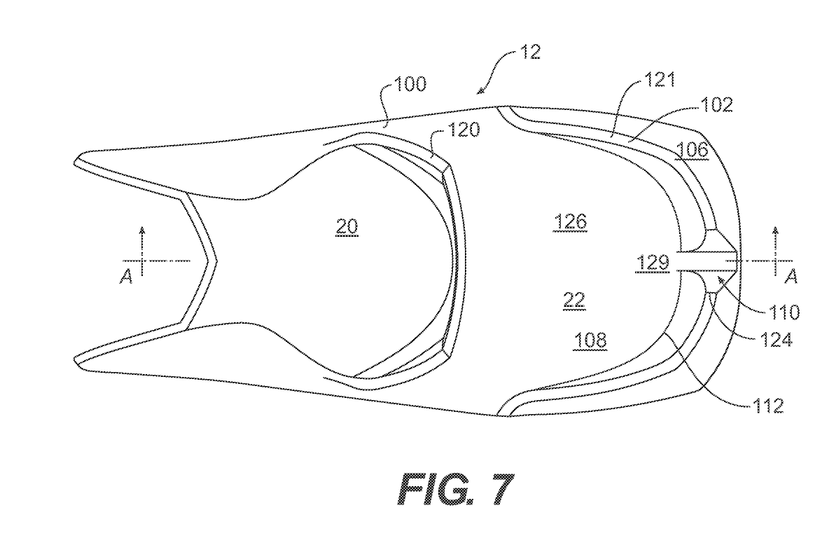

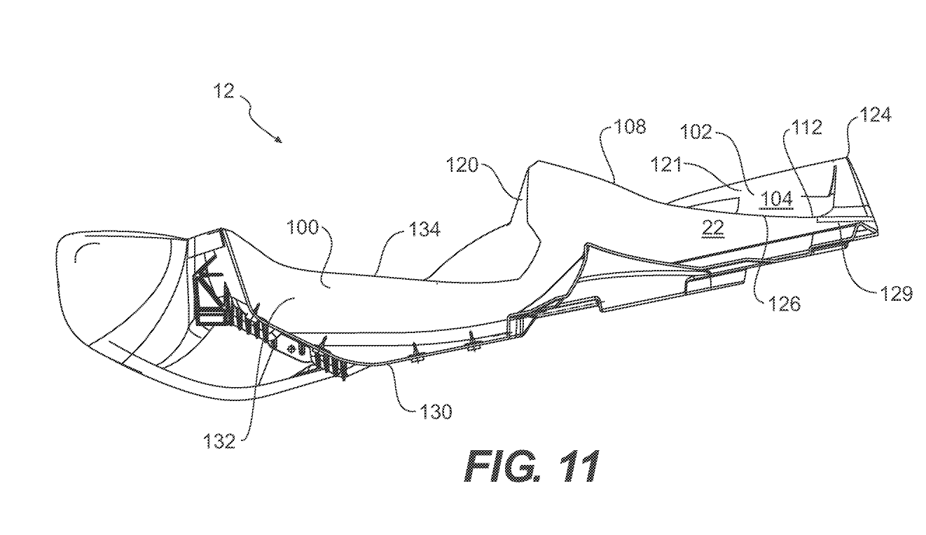

The passage 110 is a channel passing through the backrest 102 along the longitudinal center line 19. As seen in FIGS. 7 and 10, the lower portion 129 of the passage 110 coincides with a surface 108 of the elongated seat portion 100. The majority of the lower portion 129 of the passage 110 is located vertically lower than the back seat portion 22. In an alternative embodiment, the entire passage 110 is located lower than the surface 108 of the back seat portion 22 as shown in FIG. 11.

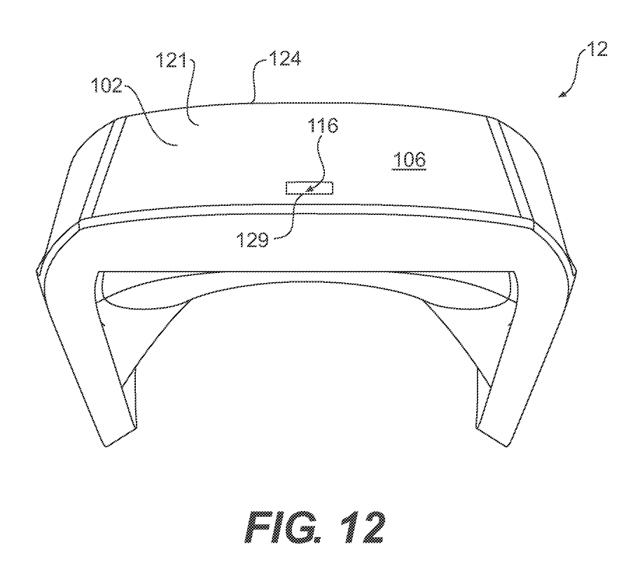

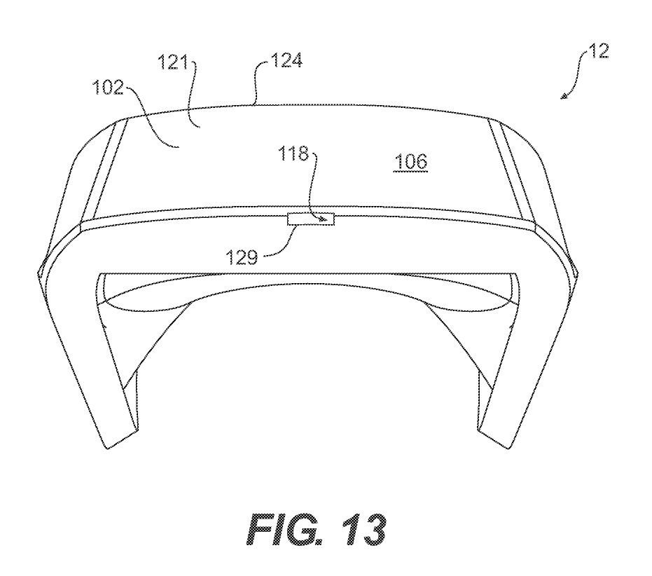

In alternative embodiments shown in FIGS. 12 and 13, the passage 110 can be an aperture 116 passing through the backrest 102 (FIG. 12) or an aperture 118 passing through the elongate seat portion 100 (FIG. 13).

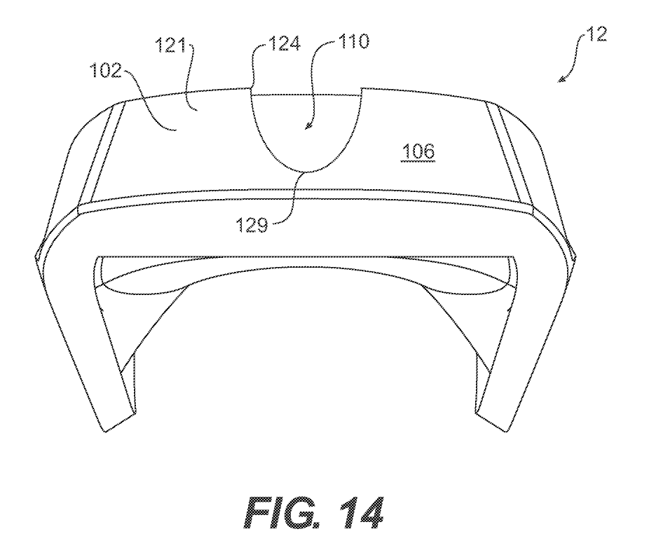

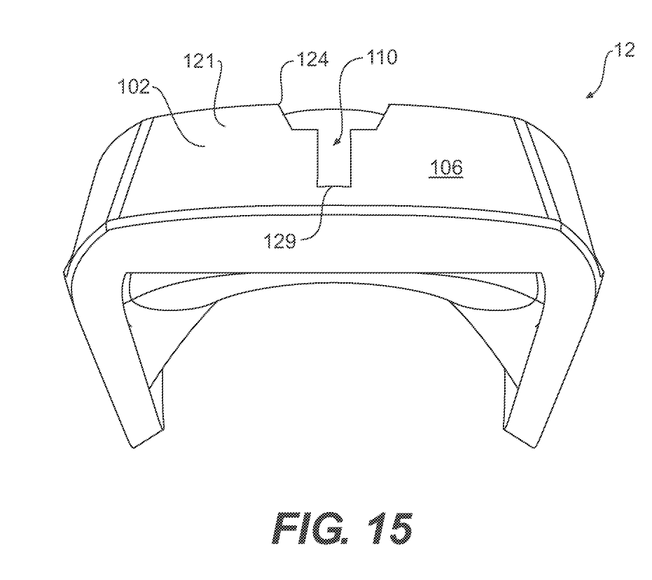

In the embodiment shown in FIGS. 6 to 11, the cross-section of the passage 110 is V-shaped. As shown in FIGS. 14 and 15, the cross-section of the passage 110 can also be U-shaped or T-shaped.

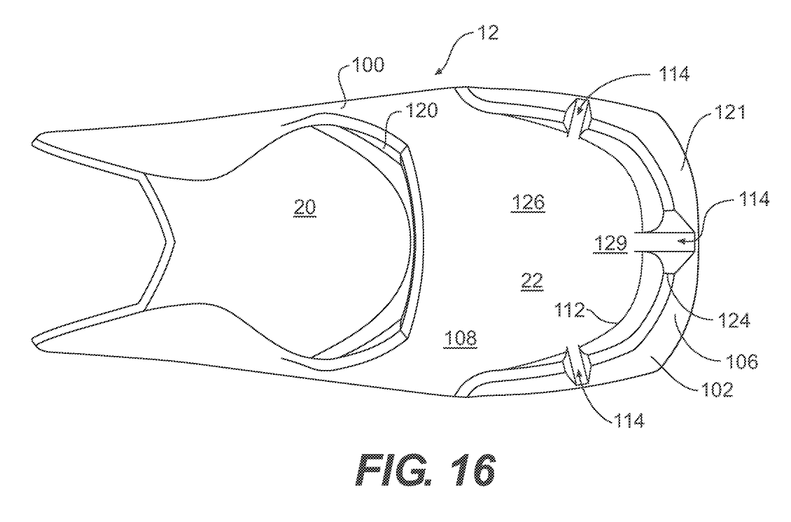

As shown in FIG. 16, it is contemplated that the seat 12 could have a plurality of passages 114. The plurality of passages 114 can be located anywhere along the junction 112 of the backrest 102 and the elongated seat portion 100. The plurality of passages 114 extends from the inner side 104 to the outer side 106 of the backrest 102.

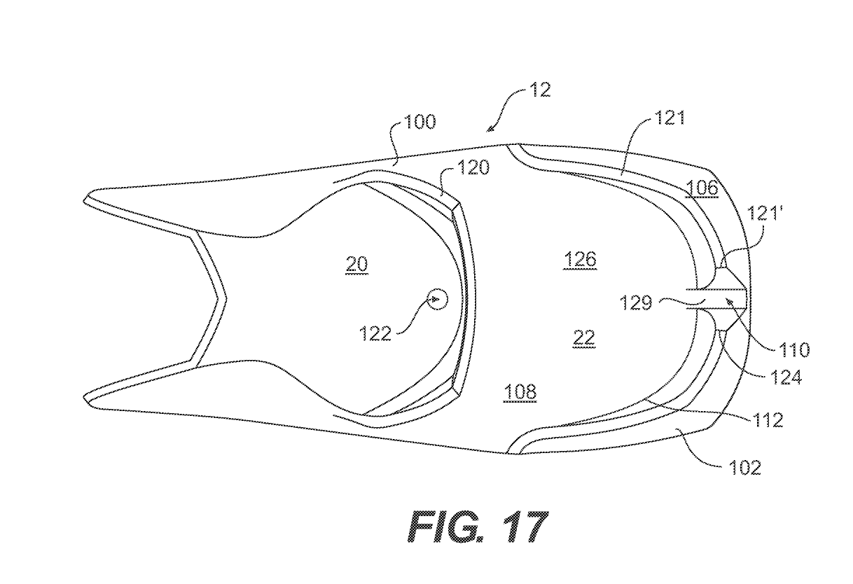

In an additional embodiment, shown in FIG. 17, an aperture 122 extends through the front seat portion 20. The aperture 122 drains the rain water which would otherwise accumulates in the area of the junction of the front seat portion 20 and a second backrest 120. The second backrest 120 is disposed between the front and back seat portions 20, 22 and is configured to provide support to at least a pelvic region of the driver.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1. A straddle-type seat comprising:
an elongated seat portion;
a backrest connected to the elongated seat portion, the backrest having an inner side and an outer side opposite the inner side, the inner side being configured to provide support to at least a pelvic region of a user, the backrest contacting a surface of the elongated seat portion; and
at least one passage located near a junction of the backrest and the elongated seat portion, the passage extending from at least the inner side to the outer side of the backrest.

2. The seat of claim 1, wherein the at least one passage is located at the junction of the backrest and the elongated seat portion.

3. The seat of claim 1, wherein the at least one passage comprises a plurality of passages.

4. The seat of claim 1, wherein the at least one passage extends through at least the backrest.

5. The seat of claim 1, wherein the at least one passage extends through at least the seat portion.

6. The seat of claim 4, wherein a shape of a cross-section of the at least one passage is one of a V-shape, a U-shape, and a T-shape.

7. The seat of claim 1, wherein the at least one passage is an aperture extending through at least the backrest.

8. The seat of claim 1, wherein the at least one passage is an aperture extending through at least the seat portion.

9. The seat of claim 1, wherein the elongated seat portion has a front seat portion and a back seat portion;
wherein the front seat portion is offset from the back seat portion;
wherein the backrest is a first backrest being configured to provide support to at least a pelvic region of a user of the back seat portion; and
wherein the seat further comprises a second backrest extending from the front seat portion to the back seat portion, the second backrest being configured to provide support to at least a pelvic region of a user of the front seat portion.

10. The seat of claim 9, further comprising an aperture extending through the front seat portion.

11. The seat of claim 1, wherein the backrest has an upper point, the upper point being a point on the backrest which is located furthest from the junction;
wherein the elongated seat portion has a seating surface disposed adjacent to the backrest;
wherein the at least one passage has a negative slope that extends in a direction away from the upper point as it extends from the inner side to the outer side of the backrest;
wherein the seating surface has a negative slope.

12.-22. (canceled)

23. The seat of claim 1, wherein the at least one passage is a channel passing through the backrest.

24. The seat of claim 23, wherein the channel extends along a longitudinal centerline of the seat.

25. The seat of claim 23, wherein the the channel has two sides, a bottom, and is opened at a top thereof.

26. The seat of claim 25, wherein each of the two sides extends to an upper point of the backrest.

27.-30. (canceled)
